(19) United States
(12) Patent Application Publication
(10) Pub. No.: US 2018/0106108 A1
(43) Pub. Date: Apr. 19, 2018

(54) SECURELY-ATTACHABLE DURABLE METAL STEP COVER WITH TRACTION SURFACE FOR ENHANCING SAFETY OF RAILROAD CAR SILL STEPS

(71) Applicant: Travis Wayne Savoy, Scott, LA (US)

(72) Inventor: Travis Wayne Savoy, Scott, LA (US)

(21) Appl. No.: 15/293,799

(22) Filed: Oct. 14, 2016

(51) Int. Cl. E06C 7/08; B61D 23/00

(52) U.S. Cl. CPC E06C 7/081; B61D 23/00

(57) ABSTRACT

A metal cover for a railcar sill step is disclosed for increased traction, safety, and durability. The metal sill step cover can be quickly and securely attached to a sill step. It has a textured metal traction surface for improving the safety of railroad car sill steps. The sill step cover includes top and front surfaces enhanced with rough metal texture so as to ensure traction when stepped on, and yet is more durable than grit-coated polyester anti-skid tape. Thus, a person is less likely to slip when using the metal step cover, which is especially important during wet or icy conditions. The step cover includes an extended clip portion for quickness and ease of attachment by bending outward so as to slide downward and then engage the rear portion of a sill step. The step cover is then secured to the sill step by screws or nuts and bolts.

### FIELD OF THE INVENTION

This invention relates generally to railroad car steps, and particularly to devices for enhancing traction on sill steps of railroad cars.

### BACKGROUND OF THE INVENTION

Sill Steps are used along the outside of railcars for entering the railcar where a platform is absent. They can be located on the back, the front, or on the sides of a railcar. They can be made from carbon steel or from stainless steel. The sill step assembly consists of a formed bar, ladder steps, and rivets securing the assembly. Sill steps are then typically riveted or screwed to the surface of the railcar. Sill steps can be used for passenger and industrial railcars.

Anti-skid material is sometimes applied to each step of a set of railcar sill steps, such as by using grit-coated polyester anti-skid tape, which can be either all black, or black and yellow striped for enhanced visibility. However, applying anti-skid tape can be problematic. For example, anti-skid tape sometimes fails to effectively adhere to one or more of the steps, due to adverse environmental conditions, such as rain, cold, or dust on the surface of the steps. Even if the anti-skid tape does adhere to the steps, the grit of the anti-skid tape tends to wear off, resulting in portions of the anti-skid tape becoming somewhat slippery, presenting a safety hazard.

### SUMMARY OF THE INVENTION

The sill step cover of the invention provides a traction surface that provides more traction than a bare sill step, and is more durable than a sill step covered with friction tape, and provides better and more reliable friction, and therefore better traction and greater safety. Thus, a person is less likely to slip when using the step. This is especially important when it's wet or icy outside.

One general aspect of the invention is a metal cover for a railway car sill step. The metal cover includes: a top plate, having a friction surface, to cover a top surface of the railway car step; a front downward flange, having a friction surface, connected to the top plate to cover a front surface of the railway car step; a front horizontal flange connected to the front downward flange to cover a bottom surface of the railway car step; a rear downward flange connected to the top plate to cover a rear surface of the railway car step; and a clip portion formed by a rear horizontal flange connected to the rear downward flange and a rearwardly angled flange connected to the rear horizontal flange, the clip portion to slidably engage the top surface of the railway car step and the rear surface of the railway car step during installation of the steel cover and to resiliently engage a bottom surface of the railway car step when the steel cover is in an installed position.

In some embodiments, the clip portion and the front horizontal flange retain the steel cover in engagement with the railway car step.

In some embodiments, the top plate covers substantially the entire top surface of the railway car step.

In some embodiments, the front downward flange, the rear downward flange, and the front horizontal flange have substantially a same length and a same width. In further embodiments, the rearwardly angled flange is shorter than the rear downward flange.

In some embodiments, the rearwardly angled flange deforms toward the rear horizontal flange when the clip portion slidably engages the top surface of the railway car step.

In some embodiments, an angle between the rear horizontal flange and the rearwardly angled flange is approximately 36 degrees.

In some embodiments, the friction surface is formed from a surface of the top plate.

In some embodiments, the friction surface is a layer attached to a surface of the top plate.

In some embodiments, the steel cover is made of galvanized steel or stainless steel.

Another general aspect of the invention is a cover for a railcar sill step, the cover including: a top plate, having a non-slip surface, to engage a top surface of the step; a front engagement potion connected to the top plate to engage a front portion of the step; and a rear engagement potion connected to the top plate to engage a rear portion of the step, the rear engagement portion including a clip portion to slidably engage the step during installation of the cover and to resiliently engage a bottom surface of the step when the cover is in an installed position.

In some embodiments, the rear engagement potion is resiliently deformable in a direction toward a rear of the step to release the clip portion from the bottom surface of the step.

In some embodiments, the clip portion deforms toward the top plate when the clip portion slidably engages the top surface of the step.

In some embodiments, a dimension of the front engagement potion and a dimension of the rear engagement portion are substantially the same. In further embodiments, the clip portion has a length substantially the same as a length of the rear engagement portion.

In some embodiments, the clip portion is angled at approximately 36 degrees to the top plate.

In some embodiments, the top plate covers the entire top surface of the railway car step.

In some embodiments, the non-slip surface is formed in a surface of the top plate.

In some embodiments, the non-slip surface is a layer attached to a surface of the top plate.

In some embodiments, the cover is made of galvanized steel or stainless steel.

### BRIEF DESCRIPTION OF THE DRAWINGS

Many additional features and advantages of the present invention will become apparent from reading the following detailed description when considered in conjunction with the accompanying figures:

FIG. 1 is a perspective view of a pair of railroad car sill steps as presently found on railroad cars, each sill step having a securely-attachable durable metal step cover of the invention attached thereto, showing the traction surface of the metal step covers.

FIG. 2 is an exploded perspective view of the still steps of FIG. 1, showing one sill step without the metal step cover of the invention, and one sill step having a metal step cover of the invention attached thereto.

FIGS. 3A-3C are side views showing how the metal step cover is attached onto a sill step:

FIG. 3A is a side view showing an initial placement of the metal step cover on a sill step.

FIG. 3B is a side view showing the front of the sill step inserted into the front of the metal step cover, and the rear of the metal step cover flexing and sliding down the rear of the sill step.

FIG. 3C is a side view showing the front of the sill step inserted into the front portion of the metal step cover, and the rear of the metal step cover fully covering the rear of the sill step.

FIG. 4 is a side view showing how the metal step cover of FIGS. 3A-3C is attached to a sill step using a nut and bolt, and using a metal screw.

### DETAILED DESCRIPTION

The invention is a device that attaches to a sill step on a railroad car to increase the traction when someone steps on one of the sill steps, the top surface of the device being covered with metal grating, such as “traction tread”.

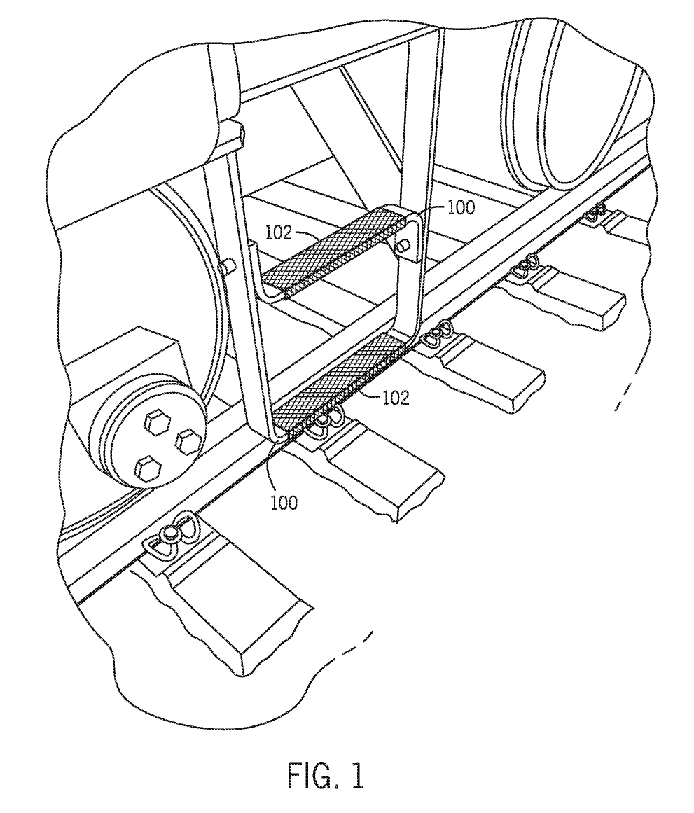

With reference to FIG. 1, a pair of sill steps 100, as presently found on railroad cars are shown, each covered by a metal step cover 102 of the invention.

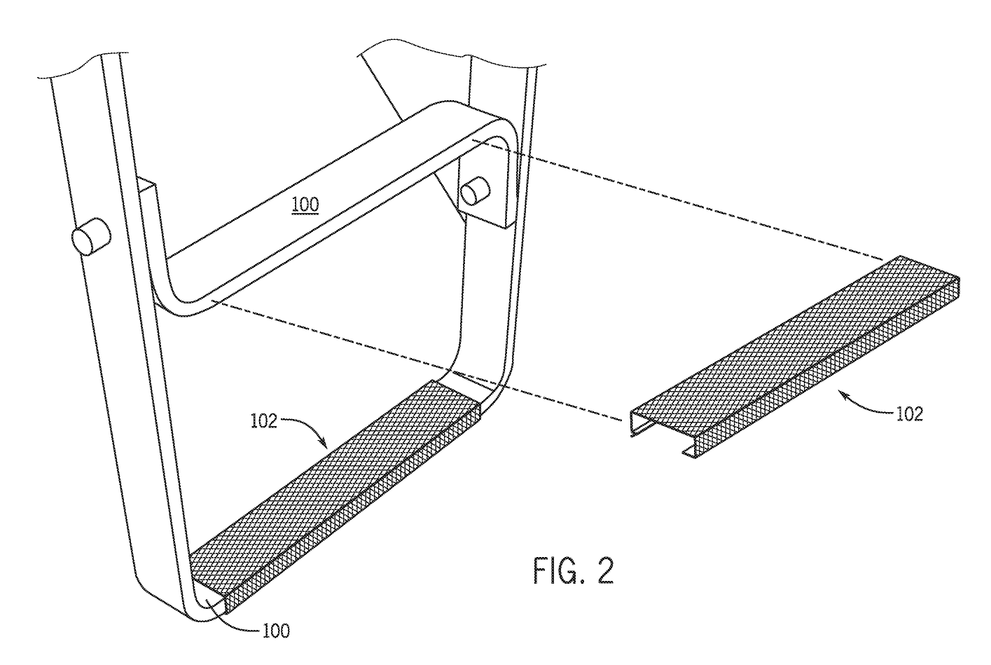

FIG. 2 shows a metal step cover 102 both attached to the lower sill step 100 of FIG. 1, and a metal step cover 102 removed from the upper sill step 100.

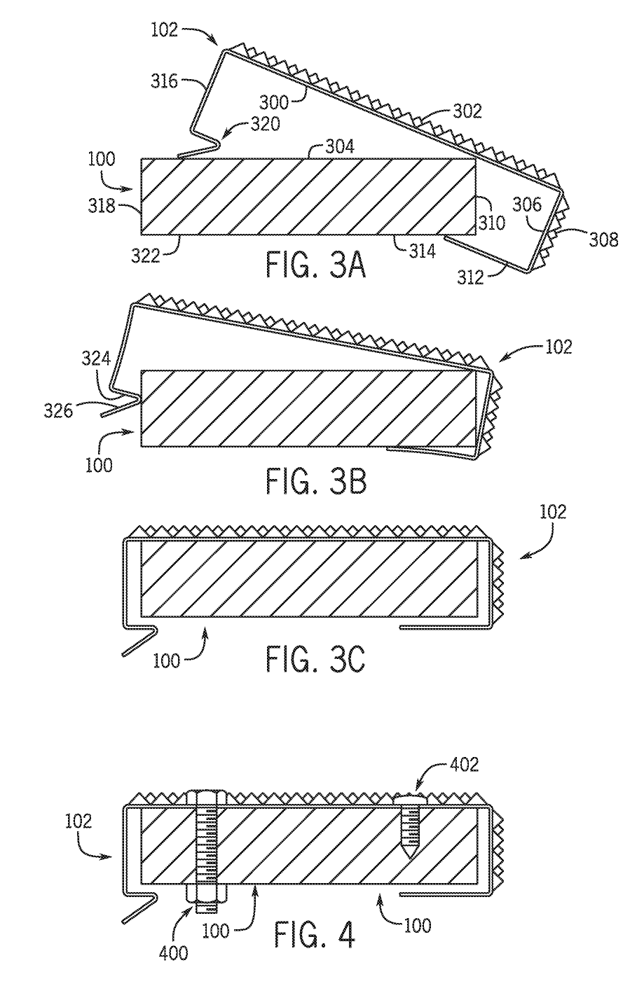

FIGS. 3A-3C show how a metal step cover 102 is attached onto a sill step 100.

In particular, FIG. 3A shows an initial placement of the metal step cover 102 on a sill step 100 by tilting the metal step cover 102.

The metal step cover 102 includes a top plate 300, having a friction surface 302, to cover a top surface 304 of the railway car sill step 100.

The metal step cover 102 also includes a front downward flange 306, having a friction surface 308, connected to the top plate 300 to cover a front surface 310 of the railway car step 100.

The metal step cover 102 also includes a front horizontal flange 312 connected to the front downward flange 306 to cover a bottom surface 314 of the railway car step 100.

The metal step cover 102 also includes a rear downward flange 316 connected to the top plate 300 to cover a rear surface 318 of the railway car step 100.

The metal step cover 102 also includes a clip portion 320 connected to the rear downward flange 316, configured to engage a rear bottom portion 322 of the railway car step 100. The clip portion 320 slidably engages the top surface 304 of the railway car step, and then the rear surface 318 of the railway car step during installation of the steel cover, as shown in FIGS. 3A and 3B. The clip portion 320 then resiliently engages a bottom surface 322 of the railway car step 100 when the metal step cover 102 is in an installed position, as shown in FIG. 3C.

As shown in FIG. 3B, the clip portion 320 is formed by a rear horizontal flange 324 connected to the rear downward flange 316, and a rearwardly angled flange 326 is connected to the rear horizontal flange 324. The clip portion 320 and the front horizontal flange 312 retain the metal step cover 102 in engagement with the railway car step 100. The top plate 300 covers substantially the entire top surface of the railway car step 100. The front downward flange 306, the rear downward flange 316, and the front horizontal flange 312 have substantially the same length and the same width. The rearwardly angled flange 326 has a length shorter than the length of the rear downward flange 316. The rearwardly angled flange 326 deforms toward the rear horizontal flange 324 when the clip portion 320 slidably engages the top surface 304 of the railway car step 100. The angle between the rear horizontal flange 324 and the rearwardly angled flange 326 is approximately 36 degrees.

The top plate 300 of the metal step cover 102 includes a friction surface 302, which rests over the top surface 304 of the railway car sill step 100. This friction surface 302 is formed from a surface of the top plate 300. In some embodiments, the friction surface 302 is a layer attached to a surface of the top plate 300. In other embodiments, the friction surface 302 is embossed, carved, etched, or stamped into the surface of the top plate 300. Likewise, the front surface 306 can be similarly textured to form a friction surface 308.

The metal step cover 102 can be made from regular steel, galvanized steel, or stainless steel.

FIG. 3B shows the front of the sill step 100 inserted into the front of the metal step cover 102, and the rear of the metal step cover 102 flexing and sliding down the rear of the sill step 100.

FIG. 3C shows the front of the sill step 100 inserted into the front portion of the metal step cover 102, and the rear of the metal step cover 102 fully covering the rear of the sill step 100, also showing how the clip portion 320 has snapped into position so as to slide under the sill step 100.

FIG. 4 shows how the metal step cover 102 is attached to the sill step 100 using a nut and bolt 400, and using a metal screw 402.

Referring again to FIGS. 3A-3C, the step cover can be 12 inches wide and 2 inches deep so as to cover the foot traffic area of a sill step 100 that is 14 inches long, for example. The front and rear surfaces 306, 316 both extend downward one half inch, for example. The front under-surface 312 extends back one half inch. The rear under-surface 324 extends forward 3/16″, and then extends downward and backwards 36 degrees from the rear under surface 324.

The step cover 102 can cut to size so as to be customized to any length. For example, if rail car has a 10 inch wide step, and the step cover purchased is 12 inches wide, one can cut 2 inches off of the step cover 102 so as to make it 10 inches wide so as to better fit on the rail car with 10 inch wide sill steps.

Other modifications and implementations will occur to those skilled in the art without departing from the spirit and the scope of the invention as claimed. Accordingly, the above description is not intended to limit the invention, except as indicated in the following claims.

What is claimed is:

1. A steel step cover for a railway car sill step, the steel step cover comprising:
a top plate, having a friction surface, to cover a top surface of the railway car sill step;
a front downward flange, having a friction surface, connected to the top plate to cover a front surface of the railway car sill step;
a front horizontal flange connected to the front downward flange to cover a bottom surface of the railway car sill step;
a rear downward flange connected to the top plate to cover a rear surface of the railway car sill step; and
a clip portion formed by a rear horizontal flange connected to the rear downward flange and a rearwardly angled flange connected to the rear horizontal flange, the clip portion to slidably engage the top surface of the railway car step and the rear surface of the railway car sill step during installation of the steel cover and to resiliently engage a bottom surface of the railway car sill step when the steel cover is in an installed position.

2. The steel cover for the railway car sill step of claim 1, wherein the clip portion and the front horizontal flange retain the steel cover in engagement with the railway car sill step.

3. The steel cover for the railway car sill step of claim 1, wherein the top plate covers substantially the entire top surface of the railway car sill step.

4. The steel cover for the railway car sill step of claim 1, wherein the front downward flange, the rear downward flange, and the front horizontal flange have substantially a same length and a same width.

5. The steel cover for the railway car sill step of claim 4, wherein the rearwardly angled flange has a length shorter than the length of the rear downward flange.

6. The steel cover for the railway car sill step of claim 1, wherein the rearwardly angled flange deforms toward the rear horizontal flange when the clip portion slidably engages the top surface of the railway car sill step.

7. The steel cover for the railway car sill step of claim 1, wherein an angle between the rear horizontal flange and the rearwardly angled flange is approximately 36 degrees.

8. The steel cover for the railway car sill step of claim 1, wherein the friction surface is formed from a surface of the top plate.

9. The steel cover for the railway car sill step of claim 1, wherein the friction surface is a layer attached to a surface of the top plate.

10. The steel cover for the railway car sill step of claim 1, wherein steel cover is made of galvanized steel or stainless steel.

11. A cover for a sill step, the cover comprising:
a top plate, having a non-slip surface, to engage a top surface of the step;
a front engagement potion connected to the top plate to engage a front portion of the step; and
a rear engagement potion connected to the top plate to engage a rear portion of the step, the rear engagement portion including a clip portion to slidably engage the step during installation of the cover and to resiliently engage a bottom surface of the step when the cover is in an installed position.

12. The cover for the sill step of claim 11, wherein the rear engagement potion is resiliently deformable in a direction toward a rear of the sill step to release the clip portion from the bottom surface of the sill step.

13. The cover for the sill step of claim 11, wherein the clip portion deforms toward the top plate when the clip portion slidably engages the top surface of the sill step.

14. The cover for the sill step of claim 11, wherein a dimension of the front engagement potion and a dimension of the rear engagement portion are substantially the same.

15. The cover for the sill step of claim 14, wherein the clip portion has a length substantially the same as a length of the rear engagement portion.

16. The cover for the sill step of claim 11, wherein the clip portion is angled at approximately 36 degrees to the top plate.

17. The cover for the sill step of claim 11, wherein the top plate covers the entire top surface of the sill step.

18. The cover for the sill step of claim 11, wherein the non-slip surface is formed in a surface of the top plate.

19. The cover for the sill step of claim 11, wherein the non-slip surface is a layer attached to a surface of the top plate.

20. The cover for the sill step of claim 11, wherein cover is made of galvanized steel or stainless steel.
